(19) United States
(12) Patent Application Publication
(10) Pub. No.: US 2017/0029574 A1
(43) Pub. Date: Feb. 2, 2017

(54) GELLED, CROSSLINKED AND NON-DRIED AQUEOUS POLYMERIC COMPOSITION, AEROGEL AND POROUS CARBON FOR SUPERCAPACITOR ELECTRODE AND PROCESSES FOR PREPARING SAME

(71) Applicant: HUTCHINSON, Paris (FR)

(72) Inventors: Yannick BUREAU, Ferrieres en Gatinais (FR); Hugo DORIE, Montargis (FR); Philippe SONNTAG, Avon (FR); Bruno DUFOUR, Champagne sur Seine (FR); Jeremie JACQUEMOND, Montargis (FR)

(73) Assignee: HUTCHINSON, Paris (FR)

(21) Appl. No.: 15/302,412

(22) PCT Filed: Apr. 7, 2014
(86) PCT No.: PCT/FR2014/050827

§ 371 Date: Oct. 6, 2016

(51) Int. Cl. C08J 3/075; H01G 11/28; H01G 11/32; H01G 11/26; C01B 31/08; C08J 9/28

(52) U.S. Cl. CPC C08J 3/075; C01B 31/089; C08J 9/28; H01G 11/32; H01G 11/26; H01G 11/28; C01P 2006/12; C01P 2006/14; C01P 2006/40; C08J 2361/12

(57) ABSTRACT

The invention relates to a gelled, crosslinked and non-dried aqueous polymeric composition capable of forming a non-monolithic organic aerogel by drying, to this aerogel, to a non-monolithic porous carbon resulting from a pyrolysis of this aerogel, to an electrode based on this porous carbon, and to a process for preparing this composition and this aerogel. The invention applies in particular to supercapacitors. A gelled, crosslinked and non-dried composition according to the invention, which is based on a resin resulting at least partly from a polycondensation of polyhydroxybenzene(s) R and formaldehyde(s) F and which comprises at least one water-soluble cationic polyelectrolyte P, is such that the composition is formed from an aqueous dispersion of microparticles of a shear-thinning physical gel that is crosslinked in an aqueous medium. The composition not yet crosslinked is in particular prepared by dilution of a prepolymer that forms this gel in an aqueous solvent in order to form the aqueous dispersion of microparticles of said gel.

The present invention relates to a gelled, crosslinked and non-dried aqueous polymeric composition capable of forming a non-monolithic organic aerogel by drying, to this aerogel, to a non-monolithic porous carbon resulting from pyrolysis of this aerogel, to an electrode based on this porous carbon, and to a process for preparing this composition and this aerogel. The invention applies in particular to supercapacitors for example suitable for equipping electric vehicles.

Organic aerogels are very promising for use as thermal insulators, because they have thermal conductivities that can be only 0.012 W·m⁻¹K⁻¹, i.e. close to those obtained with silica aerogels (0.010 W·m⁻¹K⁻¹). Indeed, they are highly porous (being both microporous and mesoporous) and have a high specific surface area and a high pore volume.

Organic aerogels with a high specific surface area are typically prepared from a resorcinol-formaldehyde (abbreviated as RF) resin. These resins are particularly advantageous for obtaining these aerogels, since they are inexpensive, can be used in water and make it possible to obtain various porosities and densities depending on the preparation conditions (ratios between reagents, choice of the catalyst, etc.). On the other hand, the gel formed by such a resin is usually an irreversible chemical gel, obtained by polycondensation of the precursors, and which can no longer be processed. Furthermore, at high conversion, this gel becomes hydrophobic and precipitates, thereby inducing mechanical stresses in the material and therefore greater weakness. Thus, for a low density of material, it is necessary to use a method of drying water that is sufficiently mild to avoid fracturing or contraction of the structure of the gel, and a loss of specific surface area. This typically involves exchange of solvent with an alcohol and then drying with a supercritical fluid such as CO₂, as described in document U.S. Pat. No. 4,997,804, or lyophilization. These techniques are complex and expensive, and it is therefore desirable to develop organic aerogels with a high specific surface area that can be obtained by means of a simpler drying method.

Resorcinol-formaldehyde organic aerogels can be pyrolysed at temperatures above 600° C. under an inert atmosphere in order to obtain carbon aerogels (i.e. porous carbons). These carbon aerogels are advantageous not only as thermal insulators that are stable at high temperature, but also as active material of electrodes for supercapacitors.

It should be remembered that supercapacitors are electrical energy storage systems that are particularly advantageous for applications which require electrical energy to be conveyed at high power. Their ability to rapidly charge and discharge, and their increased lifetime compared with a high-power battery, make them promising candidates for a number of applications. Supercapacitors generally consist of the combination of two conductive porous electrodes with a high specific surface area, immersed in an ionic electrolyte and separated by an insulating membrane called a “separator”, which allows ionic conductivity and avoids electrical contact between the electrodes. Each electrode is in contact with a metal collector which allows exchange of the electric current with an external system.

The capacities that can be achieved within supercapacitors are much higher than those achieved by conventional capacitors, owing to the use of carbon-based electrodes with a maximized specific surface area and to the extreme fineness of the double electrochemical layer (typically of a few nm thick). These carbon-based electrodes must be conductive in order to ensure transport of electric charges, porous in order to ensure transport of ionic charges and the formation of the double electrical layer over a large surface area, and chemically inert in order to avoid any energy-consuming parasitic reaction.

By way of prior art for the preparation of electrodes of supercapacitors, mention may be made of the article “A novel way to maintain resorcinol-formaldehyde porosity during drying: Stabilization of the sol-gel nanostructure using a cationic polyelectrolyte, Mariano M. Bruno et al., 2010”. This article discloses a mesoporous monolithic carbon resulting from an aqueous chemical gel of RF comprising, in addition to a sodium carbonate-based basic catalyst C, a cationic polyelectrolyte P consisting of poly(diallyldimethylammonium chloride) which makes it possible to preserve the porosity of the gel following air-drying thereof (i.e. with neither solvent exchange nor drying with a supercritical fluid). The monolithic gel is prepared with the molar ratios R:F:C:P=1:2.5:9×10⁻³:1 0.6×10⁻² and the corresponding concentrations [4M]:[10M]:[0.036M]:[0.064], by immediately polymerizing R and F in the presence of C and P at 70° C. for 24 hours. This article adds, moreover, on page 30 (left-hand column, first paragraph), that, as a “control” example, a gel in powder form was prepared with a P/R molar ratio ten times higher than that used for the monolithic gel. Given the number-average molecular weight of P equal to 4763 g/mol, it is deduced therefrom that the P/R weight ratios used for preparing the monolithic and powdered gels are respectively 0.69 and 6.91.

The monolithic irreversible chemical gels presented in said article have the major drawbacks of having a very low viscosity which makes them totally unsuitable for being coated with a thickness of less than 2 mm and, in particular for high volumes of gels which are difficult to efficiently dry, of requiring an intermediate step of converting the monolithic organic aerogel into aerogel powder (to be agglomerated with or without binder in order to obtain the final electrode). Starting from a monolith, it is therefore necessary to go through a milling step which is expensive and not very well controlled.

With regard to the chemical gels in powder form presented by way of comparison in said article, they have the drawbacks of being obtained with a very low yield and with a very low porous carbon specific surface area (of about 4 m²/g only).

The patent application filed by the applicant under PCT/IB2013/059206 presents an organic aerogel and the pyrolysate thereof in the form of a monolithic porous carbon for a supercapacitor electrode, which is typically obtained by means of the following steps:
dissolution of the resorcinol-formaldehyde precursors in water in the presence of a cationic polyelectrolyte similar to that of the abovementioned article and of a catalyst, in order to obtain an aqueous solution,
prepolymerization of this solution until it precipitates in order to obtain a prepolymer that forms a rheofluidifying physical gel,
coating or molding of this precipitated prepolymer that forms this gel with a thickness of less than 2 mm,
crosslinking and drying of this coated or molded gel in a humid oven in order to obtain a porous xerogel, and
pyrolysis of the xerogel in order to obtain the porous carbon.

In a known manner, it is moreover preferable, in order to increase the energy density of a supercapacitor, to use a coiled configuration, in which the or each cell of the supercapacitor is in the form of a cylinder consisting of layers of metal collectors coated with electrodes based on the active material and the separator, coiled about an axis. The use of monolithic electrodes is impossible in this cylindrical configuration because of the rigidity of the carbon-based active material which cannot be made to fit or curved. Furthermore, for a high-power operation, it is necessary to use a layer of active material less than 200 μm thick, and monolithic porous carbons are generally too weak at this low thickness.

In order to incorporate a porous carbon into a supercapacitor electrode, it is in particular known from documents U.S. Pat. No. 6,356,432, US-A1-2007/0146967 and U.S. Pat. No. 7,811,337 to disperse it in the form of microparticles in a non-active organic binder and in a solvent, and then to coat the paste obtained onto a current collector. It is then possible to obtain a deposited thickness of less than 200 μm and to coil the corresponding electrodes to form a cylindrical supercapacitor, owing to the fact that the porous carbon is available in the form of microparticles.

In order to obtain these porous carbons in microparticle form, the carbon monoliths described above are usually ground, which presents numerous drawbacks. Specifically, during the synthesis of the monoliths, the mixture of R and F precursors is typically placed in a closed mold, so as to form a gel after reaction. However, in order to limit the adhesion of the mixture to the mold, it is necessary to provide the mold with a typically fluorinated non-adhesive coating, which creates a high cost. Furthermore, the gelling and drying of thick monoliths is extremely lengthy, about one to several days, the milling of the monoliths also creates a high increased cost, and it can prove to be difficult to control the diameter of the microparticles obtained.

It has therefore been sought, in the past, to develop direct methods for synthesis of a powder of organic aerogel in the form of microparticles, as described in document U.S. Pat. No. 5,508,341 which presents such a method of synthesis comprising the following steps:
dispersion of an aqueous organic phase of precursors such as resorcinol-formaldehyde in a mineral oil or in a water-immiscible organic solvent,
heating of the dispersion obtained,
separation in order to remove the non-aqueous organic phase,
exchanging of the water with an organic solvent (e.g. acetone),
drying with supercritical fluid in order to obtain the organic aerogel, and optionally
pyrolysis in order to obtain a porous carbon.

This method makes it possible to obtain aerogel microspheres with diameters ranging from 1 μm to 3 mm and having relatively high specific surface areas. Nevertheless, it has the drawback of requiring the use of a mineral oil or of organic solvents, which is expensive, as is the step of drying with a supercritical fluid.

Document US-A1-2012/0286217 also describes a method for synthesis of porous carbon nanospheres, which comprises successively addition of water to a mixture of precursors such as resorcinol-formaldehyde, exchange of the water with an organic solvent, drying to extract this solvent and carbonization of the aerogel obtained.

The latter method has the drawback of requiring an organic solvent before the drying step. Furthermore, the aerogels are obtained in the form of nanoparticles that can pose toxicity problems. Finally, the porosity of the material is indeterminate.

An aim of the present invention is to provide a gelled, crosslinked and non-dried aqueous polymeric composition capable of forming a non-monolithic organic aerogel directly in the form of microparticles, which overcomes the abovementioned drawbacks while being obtained by means of a simple and inexpensive method and with rapid drying that does not require the use of an organic solvent or supercritical drying.

This aim is achieved in that the applicant has just discovered, that surprisingly prior dissolution in an aqueous phase of the RF precursors and of a water-soluble cationic polyelectrolyte P, followed by precipitation of a prepolymer obtained from this dissolution and then by dilution of the prepolymer solution in water, makes it possible to obtain an aqueous dispersion of microparticles of a rheofluidifying (shear-thinning) physical gel resulting, with a high yield, by crosslinking and then simple oven-drying, in a powdered aerogel and in its pyrolysate of porous carbon with a porosity and a specific surface area which are both very high despite this dispersion, and which are predominantly microporous.

A gelled, crosslinked and non-dried aqueous composition according to the invention which is based on a resin resulting at least partly from polycondensation of polyhydroxybenzene(s) R and formaldehyde(s) F and which comprises at least one water-soluble cationic polyelectrolyte P is thus such that the composition is formed from an aqueous dispersion of microparticles of a rheofluidifying physical gel that is crosslinked in an aqueous medium.

It will be noted that this gelled composition according to the invention in the form of a dispersion of gelled microparticles makes it possible to avoid the step of milling the gel that was required for satisfactory drying of the monolithic gels of the prior art, and resulting directly in a pulverulent aerogel by simple oven-drying.

It will also be noted that this aqueous dispersion advantageously makes it possible to obtain the gelled compositions according to the invention in a reduced period compared with the gelling processes of the prior art mentioned above implemented in a closed mold.

The term “gel” is intended to mean, in a known manner, the mixture of a colloidal material and of a liquid, which forms spontaneously or under the action of a catalyst by flocculation and coagulation of a colloidal solution. It should be reminded that a distinction is made between chemical gels and physical gels, the first having their structure due to a chemical reaction and being by definition irreversible, while for the second, the aggregation between the macromolecular chains is reversible.

It should also be reminded that the terms “shear-thinning gel” or “rheofluidifying gel” are intended to mean a gel with rheological behavior that is non-Newtonian and time-independent, that is sometimes also described as pseudoplastic and which is characterized in that its viscosity decreases when the shear rate gradient increases.

The term “water-soluble polymer” is intended to mean a polymer which can be dissolved in water without the addition of additives (of surfactants in particular), unlike a water-dispersible polymer which is capable of forming a dispersion when it is mixed with water.

It will also be noted that the composition according to the invention has the advantage, by virtue of the shear-thinning reversible gel, of being able to be used in the form of a thin layer and of having improved mechanical properties. In comparison, the non-modified RF resins of the prior art formed directly, from their precursors, an irreversible chemical gel which could not be coated in the form of a thin layer and which distorted at low thickness during pyrolysis of the gel.

The applicant has in fact discovered that said cationic polyelectrolyte P has a coagulant effect and makes it possible to neutralize the charge of the phenolates of the polyhydroxybenzene R and therefore to limit the repulsion between prepolymer colloids, promoting the formation and agglomeration of polymeric nanoparticles at low conversion of the polycondensation reaction. Furthermore, since the precipitation takes place before the crosslinking of the composition according to the invention, the mechanical stresses are lower at high conversion when the gel forms.

As a result of this, the gelled composition of the invention can be dried more easily and more rapidly—by simple oven-drying—than the aqueous gels of the prior art. This oven-drying is in fact much simpler to carry out and is less detrimental to the production cost of the gel than the drying carried out by solvent exchange and by supercritical CO₂.

It will also be noted that said at least one polyelectrolyte P makes it possible to preserve the high porosity of the gel following this oven-drying and to confer thereon a low density allied with a high specific surface area and a high pore volume, it being specified that this gel according to the invention is mainly microporous, which advantageously makes it possible to have a high specific energy and a high capacity for a supercapacitor electrode consisting of this pyrolysed gel.

According to another feature of the invention, said microparticles can have a volume median particle size, measured using a laser diffraction particle size analyzer in liquid medium, which is between 1 μm and 100 μm.

It will be noted that these microparticles differ from the potentially toxic nanoparticles that form the aerogel obtained in the abovementioned document US-A1-2012/0286217.

Advantageously, the weight fraction of said gel in said aqueous dispersion which characterizes the dilution of the solution of said prepolymer can be between 10% and 40% and preferably between 15% and 30%.

Likewise advantageously, the P/R weight ratio can be less than 0.5 and is preferably between 0.01 and 0.1.

According to another feature of the invention, said gel can be a precipitated prepolymer which is the product of a reaction of prepolymerization and precipitation of an aqueous solution of polyhydroxybenzene(s) R, of formaldehyde(s) F, of said at least one cationic polyelectrolyte P and of an acid or basic catalyst C in an aqueous solvent W, the composition being free of any organic solvent.

Advantageously, this prepolymerization and precipitation reaction product can comprise:
said at least one cationic polyelectrolyte P according to a weight fraction of between 0.2% and 3%, and/or
said polyhydroxybenzene(s) R and said aqueous solvent W according to an R/W weight ratio of between 0.01 and 2 and preferably of between 0.04 and 1.3.

Said at least one polyelectrolyte P that can be used in a composition according to the invention can be any cationic polyelectrolyte that is totally soluble in water and has a low ionic strength.

Preferably, said at least one cationic polyelectrolyte P is an organic polymer chosen from the group made up of quaternary ammonium salts, poly(vinylpyridinium chloride), poly(ethyleneimine), poly(vinylpyridine), poly(allylamine hydrochloride), poly(trimethylammonium ethyl methacrylate chloride), poly(acrylamide-co-dimethylammonium chloride), and mixtures thereof.

Even more preferentially, said at least one cationic polyelectrolyte P is a salt comprising units derived from a quaternary ammonium chosen from poly(diallyldimethylammonium halide)s, and is preferably poly(diallyldimethylammonium chloride) or poly(diallyldimethylammonium bromide).

Among the polymers that are precursors of said resin that can be used in the invention, mention may be made of those resulting from the polycondensation of at least one monomer of the polyhydroxybenzene type and of at least one formaldehyde monomer. This polymerization reaction can involve more than two distinct monomers, the additional monomers being optionally of the polyhydroxybenzene type. The polyhydroxybenzenes that can be used are preferentially di- or trihydroxybenzenes, and advantageously resorcinol (1,3-dihydroxybenzene) or the mixture of resorcinol with another compound chosen from catechol, hydroquinone and phloroglucinol.

Use may for example be made of the polyhydroxybenzene(s) R and formaldehyde(s) F according to an R/F molar ratio of between 0.3 and 0.7.

Likewise advantageously, said prepolymer that forms said shear-thinning physical gel of the composition according to the invention can have, in the non-crosslinked state, a viscosity, measured at 25° C. using a Brookfield viscometer, which, at a shear rate of 50 revolutions/minute, is greater than 100 mPa·s and is preferably between 150 mPa·s and 10 000 mPa·s, it being specified that, at 20 revolutions/minute, this viscosity is greater than 200 mPa·s and preferably greater than 250 mPa·s.

A non-monolithic organic aerogel according to the invention results from drying of said gelled, crosslinked and non-dried composition described above with reference to the invention, and this aerogel is such that it is formed from a powder of said microparticles dried by heating in an oven, said dried microparticles having a volume median particle size, measured using a laser diffraction particle size analyzer in a liquid medium, which is between 10 μm and 80 μm.

It will be noted that this particle size of the aerogel microparticles is particularly suitable for obtaining optimized properties of electrodes of supercapacitors incorporating a pyrolysate of this aerogel, as indicated below.

Advantageously, said aerogel can have a specific surface area and a pore volume which are both predominantly microporous, preferably more than 60% microporous.

It will be noted that this essentially microporous structure is by definition characterized by pore diameters of less than 2 nm, contrary to mesoporous structures such as those obtained in the abovementioned article by Mariano M. Bruno et al. which are by definition characterized by pore diameters inclusively between 2 nm and 50 nm.

Likewise advantageously, said aerogel can have a thermal conductivity of less than or equal to 40 mW·m⁻¹·K⁻¹ (also contrary to the abovementioned article), thus belonging to the family of super-insulating materials.

A non-monolithic porous carbon according to the invention results from pyrolysis of said organic aerogel carried out at a temperature typically above 600° C., and this porous carbon is such that it is formed from a powder of microspheres having a volume median particle size, measured using a laser diffraction particle size analyzer in a liquid medium, of between 10 μm and 80 μm and preferably between 10 μm and 20 μm.

Advantageously, said porous carbon can have:
a total specific surface area greater than or equal to 500 m²/g, including a microporous specific surface area greater than 400 m²/g and a mesoporous specific surface area less than 200 m²/g (contrary to the abovementioned article for the test resulting in a gel in powder form), and/or
a pore volume greater than or equal to 0.25 cm³/g, including a microporous volume greater than 0.15 cm³/g.

An electrode according to the invention can be used for equipping a supercapacitor cell by being immersed in an aqueous ionic electrolyte, the electrode covering a metal current collector, and this electrode comprises said non-monolithic porous carbon as active material and has a thickness of less than 200 μm. Preferably, this electrode has a geometry coiled about an axis that is for example approximately cylindrical.

In order to obtain the electrodes according to the invention, the porous carbon microspheres according to the invention are incorporated directly into inks, and they are coated onto a metal collector before drying them.

It will be noted that a pair of such very thin electrodes preferably coiled in a cylinder fashion makes it possible to confer a very high energy density on the supercapacitor.

A process for preparing said gelled, crosslinked and non-dried aqueous polymeric composition comprises successively:

a) dissolution of said polyhydroxybenzene(s) R and formaldehyde(s) F in an aqueous solvent W, in the presence of said at least one cationic polyelectrolyte P and of an acid or basic catalyst C, in order to obtain an aqueous solution,

b) prepolymerization of the solution obtained in a) until it precipitates in order to obtain a precipitated prepolymer that forms said shear-thinning physical gel, preferably in an oil bath at a temperature above 40° C. and for example between 45° C. and 70° C.,

c) cooling of said prepolymer, preferably to a temperature below 20° C.,

d) dilution of said prepolymer in said aqueous solvent in order to form said aqueous dispersion of microparticles of said gel, and

e) crosslinking of said prepolymer in aqueous dispersion by heating said dispersion.

Preferably, in step a), said at least one cationic polyelectrolyte P and said polyhydroxybenzene(s) R are used according to a P/R weight ratio of less than 0.5 and preferably of between 0.01 and 0.1.

Preferably, in step a):
said at least one cationic polyelectrolyte P is used according to a weight fraction of between 0.2% and 3%; and/or
said polyhydroxybenzene(s) R and said aqueous solvent W are used according to an R/W weight ratio of between 0.01 and 2 and preferably between 0.04 and 1.3.

As catalyst that can be used in step a), mention may for example be made of acid catalysts such as aqueous solutions of hydrochloric, sulfuric, nitric, acetic, phosphoric, trifluoroacetic, trifluoromethanesulfonic, perchloric, oxalic, toluenesulfonic, dichloroacetic or formic acid, or else basic catalysts such as sodium carbonate, sodium hydrogeno carbonate, potassium carbonate, ammonium carbonate, lithium carbonate, aqueous ammonia, potassium hydroxide and sodium hydroxide.

Likewise preferentially, step d) is carried out at a temperature of between 10° C. and 30° C. and according to a weight fraction of said prepolymer in said aqueous dispersion of between 10% and 40% and preferably of between 15% and 30%.

Advantageously, the heating of step e) is carried out at reflux, for at least 1 hour with stirring and at a temperature of between 80° C. and 110° C., in order to completely polymerize said gel.

Likewise advantageously, this process can comprise, after step e), a separation step f) applied to said aqueous dispersion of said crosslinked prepolymer, comprising sedimentation and elimination of the supernatant water of the dispersion, or else filtration of said dispersion.

According to another feature of the invention, this process can be advantageously free of any use of an organic solvent and of any step of obtaining and then milling a monolithic gel.

A process for preparing, according to the invention, said non-monolithic organic aerogel is such that said gelled, crosslinked and non-dried composition is dried by heating in an oven with neither solvent exchange nor drying with a supercritical fluid.

It will be noted that there is thus no need to use the expensive equipment and tools of the prior art, in particular in relation to complex milling and drying steps.

Other features, advantages and details of the present invention will emerge on reading the following description of several exemplary embodiments of the invention, given by way of nonlimiting illustration.

### Examples of Preparation According to the Invention of Gelled and Crosslinked Compositions, of Aerogels and of Porous Carbons which are Derived Therefrom, in Comparison with a “Control” Example

The examples which follow illustrate the preparation of three gelled, crosslinked and non-dried compositions G1 to G3 according to the invention, of three aerogels AG1 to AG3 according to the invention in powder form which are respectively derived therefrom by drying and of three porous carbons C1 to C3 according to the invention, respectively obtained by pyrolysis of the aerogels AG1 to AG3, in comparison with a gelled and crosslinked “control” composition G0, with an aerogel AG0 also in powder form and with a porous carbon C0 which are derived therefrom.

The applicant prepared the G0 gel, the AG0 aerogel and the C0 porous carbon under the conditions set out in said “control” example appearing on page 30 of the abovementioned article by Mariano M. Bruno et al., which mentioned, by way of comparative test, the preparation of a non-monolithic gel.

In order to obtain the organic gels G0 to G3, the following reagents were used for the polycondensation of the resorcinol R with the formaldehyde F in the presence of the catalyst C and of the polyelectrolyte P:
resorcinol (R) from Acros Organics, 98% pure,
formaldehyde (F) from Acros Organics, 37% pure,
a catalyst (C) consisting of sodium carbonate or hydrochloric acid, and
poly(diallyldimethylammonium chloride) (P), 35% pure (in solution in water W).

These reagents were used according to amounts and proportions listed in table 1 hereinafter, with
R/W: weight ratio between resorcinol and water,
R/F: molar ratio between resorcinol and formaldehyde,
R/C: molar ratio between resorcinol and catalyst, and
P/R: weight ratio between polyelectrolyte and resorcinol.

1) Preparation of the Gelled and Crosslinked Composition G1, of the Aerogel AG1 and of the Porous Carbon C1:

a) In order to prepare the gel G1, the resorcinol was firstly dissolved in the formaldehyde. The solution of calcium carbonate and the additive consisting of a solution of poly(diallyldimethylammonium chloride) at 35% were then added thereto while stirring them for 15 minutes. The pH of the mixture obtained was around 6.5.

Secondly, the non-viscous mixture was prepolymerized in a reactor immersed in an oil bath at 70° C. for 30 minutes. The prepolymer formed was then cooled to 15° C., and was then diluted to 25% in water at 25° C. The mixture obtained was refluxed in order to allow complete polymerization (crosslinking) of the RF gel. An aqueous dispersion of microparticles of the crosslinked gel G1 was then obtained. The conditions for dilution and refluxing appear in table 2 hereinafter.

b) In order to prepare the aerogel AG1, the dispersion was left to stand in order to allow sedimentation of the particles of the gel G1. The supernatant dispersant was eliminated and the wet powder obtained was placed in an oven at 70° C. for 2 hours in order to dry these microparticles.

c) In order to prepare the porous carbon C1, the aerogel AG1 was pyrolysed under nitrogen at 800° C. in order to obtain microspheres.

2) Preparation of the Gelled and Crosslinked Composition G2, of the Aerogel AG2 and of the Porous Carbon C2:

a) In order to prepare the gel G2, the resorcinol was firstly dissolved in the formaldehyde. The calcium carbonate solution and the additive consisting of a solution of poly(diallyldimethylammonium chloride) at 35% were then added thereto while stirring them for 15 minutes. The pH of the mixture obtained was 6.5.

Secondly, the non-viscous mixture was prepolymerized in a reactor immersed in an oil bath at 45° C. for 45 minutes. The mixture formed was then placed in a refrigerator at 4° C. for 24 hours. The prepolymer formed was then diluted in water. The mixture obtained was then refluxed in order to allow complete polymerization (crosslinking) of the RF gel. An aqueous dispersion of microparticles of the crosslinked gel G2 was then obtained. The conditions for dilution and refluxing are listed in table 2.

b) In order to prepare the aerogel AG2, the dispersion was left to stand in order to allow sedimentation of the particles of the gel G2. The supernatant dispersant was eliminated and the wet powder obtained was placed in an oven at 90° C. for 12 hours in order to dry these microparticles.

c) In order to prepare the porous carbon C2, the aerogel AG2 was pyrolysed under nitrogen at 800° C. in order to obtain microspheres.

3) Preparation of the Gelled and Crosslinked Composition G3, of the Aerogel AG3 and of the Porous Carbon C3:

a) In order to prepare the gel G3, the resorcinol was firstly dissolved in the water. The additive consisting of a solution of poly(diallyldimethylammonium chloride) at 35%, then the formaldehyde and, finally, the HCl catalyst were then added thereto. The mixture was then stirred for 15 minutes. The pH of the mixture obtained was 1.8.

Secondly, the non-viscous mixture was prepolymerized in a reactor immersed in an oil bath at 70° C. for 45 minutes. The mixture formed was then placed in a refrigerator at 4° C. for 24 hours. The prepolymer formed was then diluted in water. The mixture obtained was then refluxed in order to allow complete polymerization (crosslinking) of the RF gel. An aqueous dispersion of microparticles of the crosslinked gel G3 was then obtained. The conditions for dilution and refluxing are listed in table 2.

b) In order to prepare the aerogel AG3, the dispersion was left to stand in order to allow sedimentation of the microparticles of the gel G3. The supernatant dispersant was eliminated and the wet powder obtained was placed in an oven at 90° C. for 12 hours in order to dry these microparticles.

c) In order to prepare the porous carbon C3, the aerogel AG3 was pyrolysed under nitrogen at 800° C. in order to obtain microspheres.

TABLE 1

| | G1 | G2 | G3 | G0 |
|---|---|---|---|---|
| Resorcinol R | 188.7 g | 188.7 g | 96 g | 10 g |
| Water W | — | — | 1920 g | — |
| Formaldehyde F at 37% | 281.6 g | 281.6 g | 141.54 g | 18.43 g |
| in water | | | | |
| Catalyst C (Na₂CO₃) | 10.9 g | 10.9 g | — | 0.91 g |
| Catalyst C (HCl) | — | — | 27 g | — |
| Polyelectrolyte P (at 35% | 29.6 g | 29.6 | 15 g | 197.43 g |
| by weight in water) | | | | |
| R/W (g/g) | 1.13 | 1.13 | 0.048 | 0.072 |
| R/F (mol/mol) | 0.5 | 0.5 | 0.5 | 0.4 |
| R/C (mol/mol) | 174 | 174 | 33 | 111 |
| P/R (g/g) | 0.055 | 0.055 | 0.055 | 6.91 |

TABLE 2

| | G1 | G2 | G3 |
|---|---|---|---|
| Weight concentration of the gel (%) | 25 | 20 | 20 |
| Temperature of the gel during dilution (° C.) | 15 | 15 | 15 |
| Temperature of the water during dilution (° C.) | 25 | 25 | 25 |
| pH of the water | 7 | 7 | 7 |
| Reflux temperature (° C.) | 90 | 100 | 100 |
| Reflux time (h) | 2 | 1 | 1 |
| Stirring speed (revs/min.) | 500 | 500 | 500 |

For each gel G0-G3, aerogel AG0-AG3 and porous carbon C0-C3 obtained, the volume median particle sizes were measured using a MasterSizer 3000 laser diffraction particle size analyzer via the liquid process. Table 3 below gives the values of these particle sizes thus measured.

TABLE 3

| | G1 | G2 | G3 | G0 |
|---|---|---|---|---|
| | AG1 | AG2 | AG3 | AG0 |
| | C1 | C2 | C3 | C0 |
| Volume median particle size of the | 12 | 13 | 0.35 | N/A |
| dispersed prepolymer from which | | | | |
| each gel is derived (μm) | | | | |
| Volume median particle size of | 64 | — | 57 | N/A |
| each aerogel (μm) | | | | |
| Volume median particle size of | 50 | 68 | — | 30 |
| each porous carbon (μm) | | | | |

These measurements show in particular that the aerogels AG1 and AG3 and the porous carbons C1 and C2 according to the invention are in the form of microparticles having a volume average size of between 50 μm and 70 μm.

Each organic aerogel AG0-AG3 and each porous carbon C0-C3 obtained were also characterized using the technique of nitrogen adsorption manometry at 77 K by means of Tristar 3020 and ASAP 2020 instruments from the company Micromeritics. The specific surface area (respectively total, microporous and mesoporous) and pore volume (respectively total and microporous) results are presented in table 4 hereinafter.

TABLE 4

| | C1 | C2 | C3 | C0 |
|---|---|---|---|---|
| Total specific surface area | 532 | 620 | 620 | 4 |
| (m²/g) | | | | |
| Microporous specific surface | 470 | 570 | 520 | N/A |
| area (m²/g) | | | | |
| Mesoporous specific surface | 62 | 50 | 100 | N/A |
| area (m²/g) | | | | |
| Pore volume (cm³/g) | 0.27 | 0.25 | 0.30 | 0.0009 |
| Microporous volume (cm³/g) | 0.18 | 0.22 | 0.20 | N/A |

These results show that the organic aerogels AG1-AG3 and the porous carbons C1-C3 according to the invention each have, despite the aqueous dispersion used, a specific surface area (greater than 500, or even than 600 m²/g) and a pore volume that are sufficiently high to be incorporated into supercapacitor electrodes, with a microporous fraction greater than 80%, or even than 90%, for this specific surface area and greater than 60%, or even than 80%, for this pore volume. Contrary to that, the applicant verified that the porous carbon C0 according to the “control” test of said article has a specific surface area that is much too low to be useable as active material of a supercapacitor electrode.

Carbon electrodes E1, E2 and E3 were moreover prepared respectively from the porous carbons C1, C2 and C3. For that, water was mixed with binders, conductive fillers, various additives and these microspheres of each porous carbon according to the method described in example 1 of document FR-A1-2 985 598 in the name of the applicant. The formulation obtained was coated and then crosslinked on a metal collector. The capacity of the electrode E2 was measured electrochemically using the following devices and tests.

Two identical electrodes insulated by a separator were mounted in series in a measuring cell of a supercapacitor containing the aqueous electrolyte (LiNO₃, 5M) and controlled by a Bio-Logic VMP3 potentiostat/galvanostat via a three-electrode interface. The first electrode corresponds to the working electrode, the second forms the counter electrode and the reference electrode is a calomel electrode.

This capacity was measured by subjecting the system to cycles of charge-discharge at a constant current I of 1 A/g. Since the potential evolved linearly with the charge conveyed, the capacity of the supercapacitor system was deduced from the slopes p at charge and at discharge. The specific capacity of the electrode E2 thus measured was 90 F/g.

Finally, the thermal conductivity of the pulverulent aerogel AG3 obtained according to the invention was measured at 22° C. with a Neotim conductivity meter according to the hot wire technique, and this conductivity thus measured was 30 mW·m⁻¹·K⁻¹.

1. A gelled, crosslinked and non-dried aqueous polymeric composition capable of forming a non-monolithic organic aerogel by drying, the composition being based on a resin resulting at least partly from polycondensation of polyhydroxybenzene(s) R and formaldehyde(s) F and comprising at least one water-soluble cationic polyelectrolyte P, characterized in that the composition is formed from an aqueous dispersion of microparticles of a shear-thinning physical gel that is crosslinked in an aqueous medium.

2. The gelled, crosslinked and non-dried composition as claimed in claim 1, characterized in that said microparticles have a volume median particle size, measured using a laser diffraction particle size analyzer in a liquid medium, which is between 1 μm and 100 μm.

3. The gelled, crosslinked and non-dried composition as claimed in claim 1, characterized in that the weight fraction of said gel in said aqueous dispersion is between 10% and 40%.

4. The gelled, crosslinked and non-dried composition of claim 1, characterized in that the P/R weight ratio is less than 0.5 and is preferably between 0.01 and 0.1.

5. The gelled, crosslinked and non-dried composition of claim 1, characterized in that said gel is a precipitated prepolymer which is the product of a reaction of prepolymerization and precipitation of an aqueous solution of polyhydroxybenzene(s) R, of formaldehyde(s) F, of said at least one cationic polyelectrolyte P and of an acid or basic catalyst C in an aqueous solvent W, the composition being free of any organic solvent.

6. The gelled, crosslinked and non-dried composition of claim 1, characterized in that said at least one water-soluble cationic polyelectrolyte P is an organic polymer chosen from the group made up of quaternary ammonium salts, poly(vinylpyridinium chloride), poly(ethyleneimine), poly(vinylpyridine), poly(allylamine hydrochloride), poly(trimethylammonium ethyl methacrylate chloride), poly(acrylamide-co-dimethylammonium chloride), and mixtures thereof, and is preferably a salt comprising units derived from a quaternary ammonium chosen from poly(diallyldimethylammonium) halides.

7. A non-monolithic organic aerogel resulting from drying of a gelled, crosslinked and non-dried composition of claim 1, characterized in that the aerogel is formed from a powder of said microparticles dried by heating in an oven, said dried microparticles having a volume median particle size, measured using a laser diffraction particle size analyzer in a liquid medium, which is between 10 μm and 80 μm.

8. The organic aerogel as claimed in claim 7, characterized in that the aerogel has a specific surface area and a pore volume which are both predominantly microporous, preferably more than 60% microporous.

9. The organic aerogel as claimed in claim 7, characterized in that it has a thermal conductivity of less than or equal to 40 mW·m⁻¹·K⁻¹.

10. A non-monolithic porous carbon resulting from pyrolysis of an organic aerogel of claim 7, characterized in that the porous carbon is formed from a powder of microspheres having a volume median particle size, measured using a laser diffraction particle size analyzer in a liquid medium, which is between 10 μM and 80 μm and preferably between 10 μm and 20 μm.

11. The porous carbon as claimed in claim 10, characterized in that the porous carbon has:
a total specific surface area greater than or equal to 500 m²/g, including a microporous specific surface area greater than 400 m²/g and a mesoporous specific surface area less than 200 m²/g, and/or
a pore volume greater than or equal to 0.25 cm³/g, including a micropore volume greater than 0.15 cm³/g.

12. An electrode that can be used for equipping a supercapacitor cell by being immersed in an aqueous ionic electrolyte, the electrode covering a metal current collector, characterized in that the electrode comprises, as active material, a non-monolithic porous carbon of claim 10 and has a thickness of less than 200 μm, and preferably in that the electrode has a geometry coiled about an axis that is for example approximately cylindrical.

13. A process for preparing a gelled, crosslinked and non-dried aqueous polymeric composition of claim 1, characterized in that the process comprises successively:
a) dissolution of said polyhydroxybenzene(s) R and formaldehyde(s) F in an aqueous solvent W, in the presence of said at least one cationic polyelectrolyte P and of an acid or basic catalyst C, in order to obtain an aqueous solution,
b) prepolymerization of the solution obtained in a) until it precipitates in order to obtain a precipitated prepolymer that forms said shear-thinning physical gel, preferably carried out in an oil bath at a temperature above 40° C. and for example between 45° C. and 70° C.,
c) optional cooling of said prepolymer, preferably to a temperature below 20° C.,
d) dilution of said prepolymer in said aqueous solvent in order to form said aqueous dispersion of microparticles of said gel, and
e) crosslinking of said prepolymer in aqueous dispersion by heating said dispersion.

14. The process for preparing a gelled, crosslinked and non-dried aqueous polymeric composition as claimed in claim 13, characterized in that, in step a), said at least one cationic polyelectrolyte P and said polyhydroxybenzene(s) R are used according to a P/R weight ratio of less than 0.5 and preferably of between 0.01 and 0.1.

15. The process for preparing a gelled, crosslinked and non-dried aqueous polymeric composition as claimed in claim 13, characterized in that step d) is carried out at a temperature of between 10° C. and 30° C. and according to a weight fraction of said prepolymer in said aqueous dispersion of between 10% and 40% and preferably of between 15% and 30%.

16. The process for preparing a gelled, crosslinked and non-dried aqueous polymeric composition of claim 13, characterized in that the heating of step e) is carried out at reflux, for at least 1 hour with stirring and at a temperature of between 80° C. and 110° C., in order to completely polymerize said gel.

17. The process for preparing a gelled, crosslinked and non-dried aqueous polymeric composition of claim 13, characterized in that the process comprises, after step e), a separation step f) applied to said aqueous dispersion of said crosslinked prepolymer, comprising sedimentation and elimination of the supernatant water of the dispersion, or else filtration of said dispersion.

18. The process for preparing a gelled, crosslinked and non-dried aqueous polymeric composition of claim 13, characterized in that the process is free of any use of an organic solvent, of any step of obtaining a monolithic gel and of any step of milling a monolithic gel.

19. A process for preparing a non-monolithic organic aerogel of claim 7, characterized in that said gelled, crosslinked and non-dried composition is dried by heating in an oven with neither solvent exchange nor drying with a supercritical fluid.
